(19) United States
(12) Patent Application Publication
(10) Pub. No.: US 2024/0119152 A1
(43) Pub. Date: Apr. 11, 2024

(54) PROVIDING MALWARE PROTECTION ON AN UNMANNED AERIAL VEHICLE

(71) Applicant: SKYGRID, LLC, AUSTIN, TX (US)

(72) Inventors: SYED MOHAMMAD ALI, LEANDER, TX (US); LOWELL L. DUKE, AUSTIN, TX (US); ZEHRA AKBAR, LEANDER, TX (US); SYED MOHAMMAD AMIR HUSAIN, GEORGETOWN, TX (US); TAYLOR R. SCHMIDT, AUSTIN, TX (US); MILTON LOPEZ, ROUND ROCK, TX (US); RAVI TEJA PINNAMANENI, AUSTIN, TX (US)

(21) Appl. No.: 18/174,274

(22) Filed: Feb. 24, 2023

Related U.S. Application Data
(60) Provisional application No. 63/315,701, filed on Mar. 2, 2022.

(51) Int. Cl. G06F 21/56

(52) U.S. Cl. CPC G06F 21/566; B64U 2101/00

(57) ABSTRACT

Methods, systems, apparatuses, and computer program products for providing malware protection on a UAV are disclosed. In a particular embodiment, a method of providing malware protection on a UAV includes a malware defense controller initiating, on an unmanned aerial vehicle (UAV) in response to a malware defense event, a malware defense scan of at least one file stored on the UAV. In this embodiment, the malware defense controller also implements, in dependence upon a result of a malware detection analysis, a malware defense operation.

### BACKGROUND

An Unmanned Aerial Vehicle (UAV) is a term used to describe an aircraft with no pilot on-board the aircraft. The use of UAVs is growing in an unprecedented rate, and it is envisioned that UAVs will become commonly used for package delivery and passenger air taxis. However, as UAVs become more prevalent in the airspace, there is a need to regulate air traffic and ensure the safe navigation of the UAVs.

The Unmanned Aircraft System Traffic Management (UTM) is an initiative sponsored by the Federal Aviation Administration (FAA) to enable multiple beyond visual line-of-sight drone operations at low altitudes (under (400) feet above ground level (AGL) in airspace where FAA air traffic services are not provided. However, a framework that extends beyond the (400) feet AGL limit is needed. For example, unmanned aircraft that would be used by package delivery services and air taxis may need to travel at altitudes above (400) feet. Such a framework requires technology that will allow the FAA to safely regulate unmanned aircraft.

### SUMMARY

Methods, systems, apparatuses, and computer program products for providing malware protection on an unmanned aerial vehicle (UAV) are disclosed. In a particular embodiment, a method of providing malware protection on a UAV includes a malware defense controller initiating, on UAV in response to a malware defense event, a malware defense scan of at least one file stored on the UAV. In this embodiment, the malware defense controller also implements, in dependence upon a result of a malware detection analysis, a malware defense operation.

As will be explained below, protecting UAVs from malware and cyber-attacks is important to prevent the hijacking of UAVs, disruption of UAV missions, and theft of data collected by and stored on the UAV. For example, malware on a UAV could expose a back door that would allow a malicious actor to take control of the UAV, or allow a malicious actor to learn the details of missions the UAV has been tasked with completing. Providing malware protection on a UAV presents a unique set of challenges. For example, a malware attack that occurs while a UAV is in flight could break communication with the UAV controller or other remote devices. In such a scenario, it is advantageous to provide the UAV with autonomous capability for detecting and responding to a malware attack. Further, as with all computing devices, UAVs are susceptible to zero-day malware attacks. Accordingly, embodiments in accordance with the present disclosure address these issues.

The foregoing and other objects, features, and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 is a block diagram illustrating a particular implementation of a system of providing malware protection on an unmanned aerial vehicle (UAV) according to at least one embodiment of the present invention;

FIG. 2 is a block diagram illustrating a particular implementation of a system of providing malware protection on a UAV according to at least one embodiment of the present invention;

FIG. 3A a block diagram illustrating a particular implementation of the blockchain used by the systems of FIGS. 1-2 to record data associated with an unmanned aerial vehicle;

FIG. 3B is an additional view of the blockchain of FIG. 3A;

FIG. 3C is an additional view of the blockchain of FIG. 3A;

FIG. 4 sets forth a block diagram illustrating another implementation of a system for providing malware protection on a UAV;

FIG. 5 is a block diagram illustrating a particular implementation of a method of providing malware protection on a UAV according to at least one embodiment of the present invention;

FIG. 6 is a block diagram illustrating a particular implementation of a method of providing malware protection on a UAV according to at least one embodiment of the present invention;

FIG. 7 is a block diagram illustrating a particular implementation of a method of providing malware protection on a UAV according to at least one embodiment of the present invention;

FIG. 8 is a block diagram illustrating a particular implementation of a method of providing malware protection on a UAV according to at least one embodiment of the present invention; and

FIG. 9 is a block diagram illustrating a particular implementation of a method of providing malware protection on a UAV according to at least one embodiment of the present invention.

### DETAILED DESCRIPTION

Particular aspects of the present disclosure are described below with reference to the drawings. In the description, common features are designated by common reference numbers throughout the drawings. As used herein, various terminology is used for the purpose of describing particular implementations only and is not intended to be limiting. For example, the singular forms “a,” “an,” and “the” are intended to include the plural forms as well, unless the context clearly indicates otherwise. It may be further understood that the terms “comprise,” “comprises,” and “comprising” may be used interchangeably with “include,” “includes,” or “including.” Additionally, it will be understood that the term “wherein” may be used interchangeably with “where.” As used herein, “exemplary” may indicate an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to a grouping of one or more elements, and the term “plurality” refers to multiple elements.

In the present disclosure, terms such as “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “generating,” “calculating,” “estimating,” “using,” “selecting,” “accessing,” and “determining” may be used interchangeably. For example, “generating,” “calculating,” “estimating,” or “determining” a parameter (or a signal) may refer to actively generating, estimating, calculating, or determining the parameter (or the signal) or may refer to using, selecting, or accessing the parameter (or signal) that is already generated, such as by another component or device.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive electrical signals (digital signals or analog signals) directly or indirectly, such as via one or more wires, buses, networks, etc. As used herein, “directly coupled” may include two devices that are coupled (e.g., communicatively coupled, electrically coupled, or physically coupled) without intervening components.

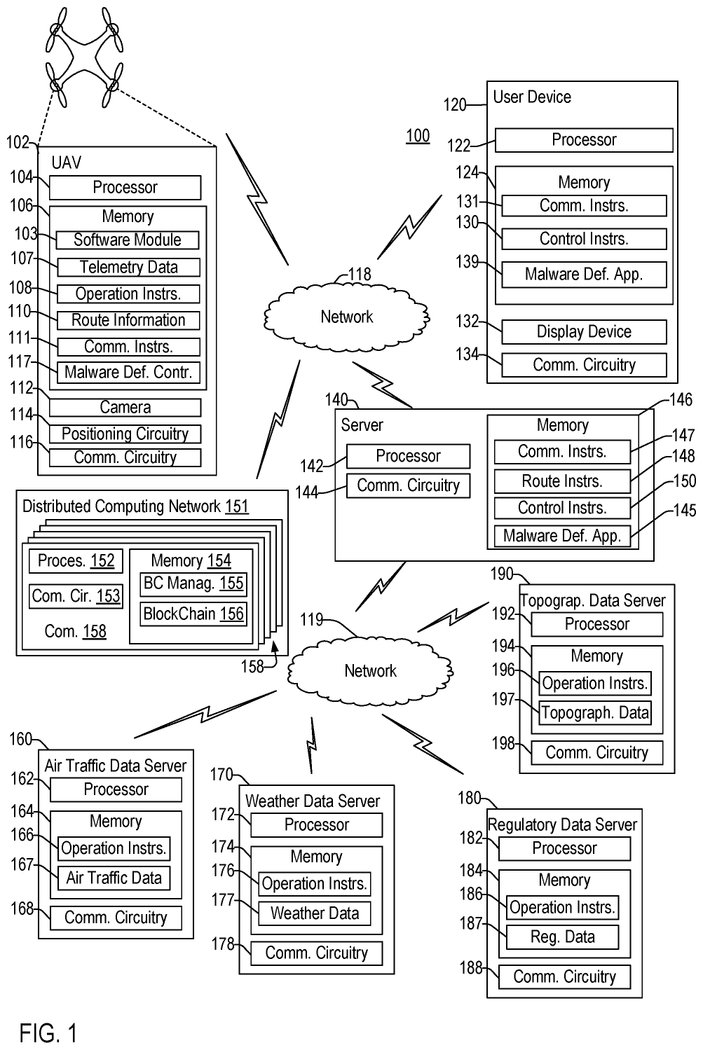

Exemplary methods, apparatuses, and computer program products of providing malware protection on a UAV in accordance with the present invention are described with reference to the accompanying drawings, beginning with FIG. 1. FIG. 1 sets forth a diagram of a system 100 configured of providing malware protection on a UAV according to embodiments of the present disclosure. The system 100 of FIG. 1 includes an unmanned aerial vehicle (UAV) 102, a user device 120, a server 140, a distributed computing network 151, an air traffic data server 160, a weather data server 170, a regulatory data server 180, and a topographic data server 190.

A UAV, commonly known as a drone, is a type of powered aerial vehicle that does not carry a human operator and uses aerodynamic forces to provide vehicle lift. UAVs are a component of an unmanned aircraft system (UAS), which typically include at least a UAV, a control device, and a system of communications between the two. The flight of a UAV may operate with various levels of autonomy including under remote control by a human operator or autonomously by onboard or ground computers. Although a UAV may not include a human operator pilot, some UAVs, such as passenger drones (drone taxi, flying taxi, or pilotless helicopter) carry human passengers.

For ease of illustration, the UAV 102 is illustrated as one type of drone. However, any type of UAV may be used in accordance with embodiments of the present disclosure and unless otherwise noted, any reference to a UAV in this application is meant to encompass all types of UAVs. Readers of skill in the art will realize that the type of drone that is selected for a particular mission or excursion may depend on many factors, including but not limited to the type of payload that the UAV is required to carry, the distance that the UAV must travel to complete its assignment, and the types of terrain and obstacles that are anticipated during the assignment.

In FIG. 1, the UAV 102 includes a processor 104 coupled to a memory 106, a camera 112, positioning circuitry 114, and communication circuitry 116. The communication circuitry 116 includes a transmitter and a receiver or a combination thereof (e.g., a transceiver). In a particular implementation, the communication circuitry 116 (or the processor 104) is configured to encrypt outgoing message(s) using a private key associated with the UAV 102 and to decrypt incoming message(s) using a public key of a device (e.g., the user device 120 or the server 140 that sent the incoming message(s). As will be explained further below, the outgoing and incoming messages may be transaction messages that include information associated with the UAV. Thus, in this implementation, communications between the UAV 102, the user device 120, and the server 140 are secure and trustworthy (e.g., authenticated).

The camera 112 is configured to capture image(s), video, or both, and can be used as part of a computer vision system. For example, the camera 112 may capture images or video and provide the video or images to a pilot of the UAV 102 to aid with navigation. Additionally, or alternatively, the camera 112 may be configured to capture images or video to be used by the processor 104 during performance of one or more operations, such as a landing operation, a takeoff operation, or object/collision avoidance, as non-limiting examples. Although a single camera 112 is shown in FIG. 1, in alternative implementations more and/or different sensors may be used (e.g., infrared, LIDAR, SONAR, etc.).

The positioning circuitry 114 is configured to determine a position of the UAV 102 before, during, and/or after flight. For example, the positioning circuitry 114 may include a global positioning system (GPS) interface or sensor that determines GPS coordinates of the UAV 102. The positioning circuitry 114 may also include gyroscope(s), accelerometer(s), pressure sensor(s), other sensors, or a combination thereof, that may be used to determine the position of the UAV 102.

The processor 104 is configured to execute instructions stored in and retrieved from the memory 106 to perform various operations. For example, the instructions include operation instructions 108 that include instructions or code that cause the UAV 102 to perform flight control operations. The flight control operations may include any operations associated with causing the UAV to fly from an origin to a destination. For example, the flight control operations may include operations to cause the UAV to fly along a designated route (e.g., based on route information 110, as further described herein), to perform operations based on control data received from one or more control devices, to take off, land, hover, change altitude, change pitch/yaw/roll angles, or any other flight-related operations. The UAV 102 may include one or more actuators, such as one or more flight control actuators, one or more thrust actuators, etc., and execution of the operation instructions 108 may cause the processor 104 to control the one or more actuators to perform the flight control operations. The one or more actuators may include one or more electrical actuators, one or more magnetic actuators, one or more hydraulic actuators, one or more pneumatic actuators, one or more other actuators, or a combination thereof.

The route information 110 may indicate a flight path for the UAV 102 to follow. For example, the route information 110 may specify a starting point (e.g., an origin) and an ending point (e.g., a destination) for the UAV 102. Additionally, the route information may also indicate a plurality of waypoints, zones, areas, regions between the starting point and the ending point.

The route information 110 may also indicate a corresponding set of control devices for various points, zones, regions, areas of the flight path. The indicated sets of control devices may be associated with a pilot (and optionally one or more backup pilots) assigned to have control over the UAV 102 while the UAV 102 is in each zone. The route information 110 may also indicate time periods during which the UAV is scheduled to be in each of the zones (and thus time periods assigned to each pilot or set of pilots).

The memory 106 of the UAV 102 may also include communication instructions 111 that when executed by the processor 104 cause the processor 104 to transmit to the distributed computing network 151, transaction messages that include telemetry data 107. Telemetry data may include any information that could be useful to identifying the location of the UAV, the operating parameters of the UAV, or the status of the UAV. Examples of telemetry data include but are not limited to GPS coordinates, instrument readings (e.g., airspeed, altitude, altimeter, turn, heading, vertical speed, attitude, turn and slip), and operational readings (e.g., pressure gauge, fuel gauge, battery level).

In the example of FIG. 1, the memory 106 of the UAV 102 further includes at least one UAV software module 103. The UAV software module 103 is defined as a group of computer executable code that, when executed by a processor, enables at least one specialized functionality of a UAV that may not normally be present on the UAV. For example, in the embodiment of FIG. 1, the camera 112 may normally be configured to take pictures. The UAV software module 103 may be executed by processor 104 to enable additional functionality of the camera 112, such as object detection or tracking. The UAV software module 103 may work in conjunction with the existing hardware of the UAV 102, such as shown in FIG. 1, or in other examples, the UAV software module 103 may work in conjunction with optional hardware. For example, a UAV software module 103 may work in combination with a sensor not normally present on the UAV 102. In such examples, adding the sensor to the UAV 102 may only be enabled once the appropriate software module is enabled. Likewise, the UAV software module 103 may not be functional unless the additional sensor is present on the UAV 102. Examples of functionality that may be enabled by a software module include, but are not limited to, object detection, automated flight patterns, object tracking, object counting, or responses to object detection.

In the example of FIG. 1, the memory 106 of the UAV 102 further includes a malware defense controller 117. In a particular embodiment, the malware defense controller 117 includes computer program instructions that when executed by the processor 104 cause the processor 104 to carry out the operations of initiating, on a UAV in response to a malware defense event, a malware defense scan of at least one file stored on the UAV; and implementing, by the UAV in dependence upon a result of a malware detection analysis, a malware defense operation. In an embodiment, the malware defense controller 117 further includes instruction that, when executed by the processor 104, cause the processor 104 to carry out the operations of generating, by the UAV, metadata for the at least one file; and performing, by the UAV based on at least the metadata, the malware detection analysis of the at least one file. In an embodiment, the malware defense controller 117 further includes instruction that, when executed by the processor 104, cause the processor 104 to carry out the operations of storing, on the UAV, a trained classification model; and wherein performing, by the UAV based on at least the metadata, the malware detection analysis of the at least one file includes generating, in dependence upon the metadata and the trained classification model, malware classification data for the at least one file, wherein the malware classification data indicates whether the at least one file includes suspected malware. In an embodiment, the malware defense controller 117 further includes instruction that, when executed by the processor 104, cause the processor 104 to carry out the operations of generating, by the UAV, metadata for the at least one file; transmitting, by the UAV, the metadata to a remote device associated with the UAV; and receiving, by the UAV, the result of the malware detection analysis from the remote device.

The user device 120 includes a processor 122 coupled to a memory 124, a display device 132, and communication circuitry 134. The display device 132 may be a liquid crystal display (LCD) screen, a touch screen, another type of display device, or a combination thereof. The communication circuitry 134 includes a transmitter and a receiver or a combination thereof (e.g., a transceiver). In a particular implementation, the communication circuitry 134 (or the processor 122 is configured to encrypt outgoing message(s) using a private key associated with the user device 120 and to decrypt incoming message(s) using a public key of a device (e.g., the UAV 102 or the server 140 that sent the incoming message(s). Thus, in this implementation, communication between the UAV 102, the user device 120, and the server 140 are secure and trustworthy (e.g., authenticated).

The processor 122 is configured to execute instructions from the memory 124 to perform various operations. The instructions include control instructions 130 that include instructions or code that cause the user device 120 to generate control data to transmit to the UAV 102 to enable the user device 120 to control one or more operations of the UAV 102 during a particular time period, as further described herein.

In the example of FIG. 1, the memory 124 of the user device 120 also includes communication instructions 131 that when executed by the processor 122 cause the processor 122 to transmit to the distributed computing network 151, messages that include control instructions 130 that are directed to the UAV 102. In a particular embodiment, the transaction messages are also transmitted to the UAV and the UAV takes action (e.g., adjusting flight operations), based on the information (e.g., control data) in the message.

In addition, the memory 124 of the user device 120 may also include malware defense application 139. In a particular embodiment, the malware defense application 139 includes computer program instructions that when executed by the processor 122 cause the processor 122 to carry out the operations of initiating, on a UAV in response to a malware defense event, a malware defense scan of at least one file stored on the UAV; and implementing, in dependence upon a result of a malware detection analysis, a malware defense operation. In an embodiment, the malware defense application 139 further includes instruction that, when executed by the processor 122, cause the user device 120 to carry out the operations of performing, based on at least the metadata, the malware detection analysis of the at least one file. In an embodiment, performing, based on at least the metadata, the malware detection analysis of the at least one file includes generating, in dependence upon the metadata and the trained classification model, malware classification data for the at least one file, wherein the malware classification data indicates whether the at least one file includes suspected malware. In an embodiment, the malware defense application 139 further includes instruction that, when executed by the processor 122, cause the user device 120 to carry out the operations of transmitting, to the UAV, the result of the malware detection analysis from the remote device.

The server 140 includes a processor 142 coupled to a memory 146, and communication circuitry 144. The communication circuitry 144 includes a transmitter and a receiver or a combination thereof (e.g., a transceiver). In a particular implementation, the communication circuitry 144 (or the processor 142 is configured to encrypt outgoing message(s) using a private key associated with the server 140 and to decrypt incoming message(s) using a public key of a device (e.g., the UAV 102 or the user device 120 that sent the incoming message(s). As will be explained further below, the outgoing and incoming messages may be transaction messages that include information associated with the UAV. Thus, in this implementation, communication between the UAV 102, the user device 120, and the server 140 are secure and trustworthy (e.g., authenticated).

The processor 142 is configured to execute instructions from the memory 146 to perform various operations. The instructions include route instructions 148 comprising computer program instructions for aggregating data from disparate data servers, virtualizing the data in a map, generating a cost model for paths traversed in the map, and autonomously selecting the optimal route for the UAV based on the cost model. For example, the route instructions 148 are configured to partition a map of a region into geographic cells, calculate a cost for each geographic cell, wherein the cost is a sum of a plurality of weighted factors, determine a plurality of flight paths for the UAV from a first location on the map to a second location on the map, wherein each flight path traverses a set of geographic cells, determine a cost for each flight path based on the total cost of the set of geographic cells traversed, and select, in dependence upon the total cost of each flight path, an optimal flight path from the plurality of flight paths. The route instructions 148 are further configured to obtain data from one or more data servers regarding one or more geographic cells, calculate, in dependence upon the received data, an updated cost for each geographic cell traversed by a current flight path, calculate a cost for each geographic cell traversed by at least one alternative flight path from the first location to the second location, determine that at least one alternative flight path has a total cost that is less than the total cost of the current flight path, and select a new optimal flight path from the at least one alternative flight paths. The route instructions 148 may also include instructions for storing the parameters of the selected optimal flight path as route information 110. For example, the route information may include waypoints marked by GPS coordinates, arrival times for waypoints, pilot assignments.

The instructions may also include control instructions 150 that include instructions or code that cause the server 140 to generate control data to transmit to the UAV 102 to enable the server 140 to control one or more operations of the UAV 102 during a particular time period, as further described herein.

In addition, the memory 146 of the server 140 may also include a malware defense application 145. In a particular embodiment, the malware defense application 145 includes computer program instructions that when executed by the processor 142 cause the processor 142 to carry out the operations of initiating, on a UAV in response to a malware defense event, a malware defense scan of at least one file stored on the UAV; and implementing, in dependence upon a result of a malware detection analysis, a malware defense operation. In an embodiment, the malware defense application 145 further includes instruction that, when executed by the processor 122, cause the processor 142 to carry out the operations of performing, based on at least the metadata, the malware detection analysis of the at least one file. In an embodiment, performing, based on at least the metadata, the malware detection analysis of the at least one file includes generating, in dependence upon the metadata and the trained classification model, malware classification data for the at least one file, wherein the malware classification data indicates whether the at least one file includes suspected malware. In an embodiment, the malware defense application 145 further includes instruction that, when executed by the processor 142, cause the processor 142 to carry out the operations of transmitting, to the UAV, the result of the malware detection analysis from the remote device.

In the example of FIG. 1, the memory 146 of the server 140 also includes communication instructions 147 that when executed by the processor 142 cause the processor 142 to transmit to the distributed computing network 151, transaction messages that include control instructions 150 that are directed to the UAV 102.

The distributed computing network 151 of FIG. 1 includes a plurality of computers. An example computer 158 of the plurality of computers is shown and includes a processor 152 coupled to a memory 154, and communication circuitry 153. The communication circuitry 153 includes a transmitter and a receiver or a combination thereof (e.g., a transceiver). In a particular implementation, the communication circuitry 153 (or the processor 152 is configured to encrypt outgoing message(s) using a private key associated with the computer 158 and to decrypt incoming message(s) using a public key of a device (e.g., the UAV 102, the user device 120, or the server 140 that sent the incoming message(s). As will be explained further below, the outgoing and incoming messages may be transaction messages that include information associated with the UAV 102. Thus, in this implementation, communication between the UAV 102, the user device 120, the server 140, and the distributed computing network 151 are secure and trustworthy (e.g., authenticated).

The processor 152 is configured to execute instructions from the memory 154 to perform various operations. The memory 154 includes a blockchain manager 155 that includes computer program instructions for utilizing an unmanned aerial vehicle for emergency response. Specifically, the blockchain manager 155 includes computer program instructions that when executed by the processor 152 cause the processor 152 to receive a transaction message associated with a UAV. For example, the blockchain manager may receive transaction messages from the UAV 102, the user device 120, or the server 140. The blockchain manager 155 also includes computer program instructions that when executed by the processor 152 cause the processor 152 to use the information within the transaction message to create a block of data; and store the created block of data in a blockchain data structure 156 associated with the UAV 102.

The blockchain manager may also include instructions for accessing information regarding an unmanned aerial vehicle (UAV). For example, the blockchain manager 155 also includes computer program instructions that when executed by the processor 152 cause the processor to receive from a device, a request for information regarding the UAV; in response to receiving the request, retrieve from a blockchain data structure associated with the UAV, data associated with the information requested; and based on the retrieved data, respond to the device.

The UAV 102, the user device 120, and the server 140 are communicatively coupled via a network 118. For example, the network 118 may include a satellite network or another type of network that enables wireless communication between the UAV 102, the user device 120, the server 140, and the distributed computing network 151. In an alternative implementation, the user device 120 and the server 140 communicate with the UAV 102 via separate networks (e.g., separate short-range networks.

In some situations, minimal (or no) manual control of the UAV 102 may be performed, and the UAV 102 may travel from the origin to the destination without incident. In some examples, a UAV software module may enable the minimal (or no) manual control operation of the UAV 102. However, in some situations, one or more pilots may control the UAV 102 during a time period, such as to perform object avoidance or to compensate for an improper UAV operation. In some situations, the UAV 102 may be temporarily stopped, such as during an emergency condition, for recharging, for refueling, to avoid adverse weather conditions, responsive to one or more status indicators from the UAV 102, etc. In some implementations, due to the unscheduled stop, the route information 110 may be updated (e.g., via a subsequent blockchain entry, as further described herein) by route instructions 148 executing on the UAV 102, the user device 120, or the server 140). The updated route information may include updated waypoints, updated time periods, and updated pilot assignments.

In a particular implementation, the route information is exchanged using a blockchain data structure. The blockchain data structure may be shared in a distributed manner across a plurality of devices of the system 100, such as the UAV 102, the user device 120, the server 140, and any other control devices or UAVs in the system 100. In a particular implementation, each of the devices of the system 100 stores an instance of the blockchain data structure in a local memory of the respective device. In other implementations, each of the devices of the system 100 stores a portion of the shared blockchain data structure and each portion is replicated across multiple devices of the system 100 in a manner that maintains security of the shared blockchain data structure as a public (i.e., available to other devices) and incorruptible (or tamper evident) ledger. Alternatively, as in FIG. 1, the blockchain data structure 156 is stored in a distributed manner in the distributed computing network 151.

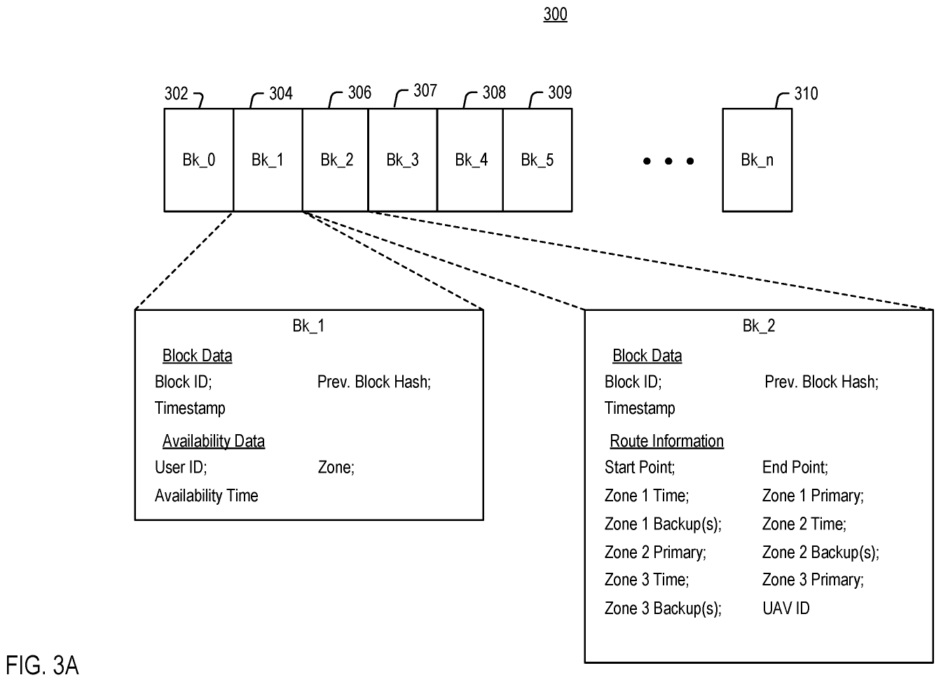

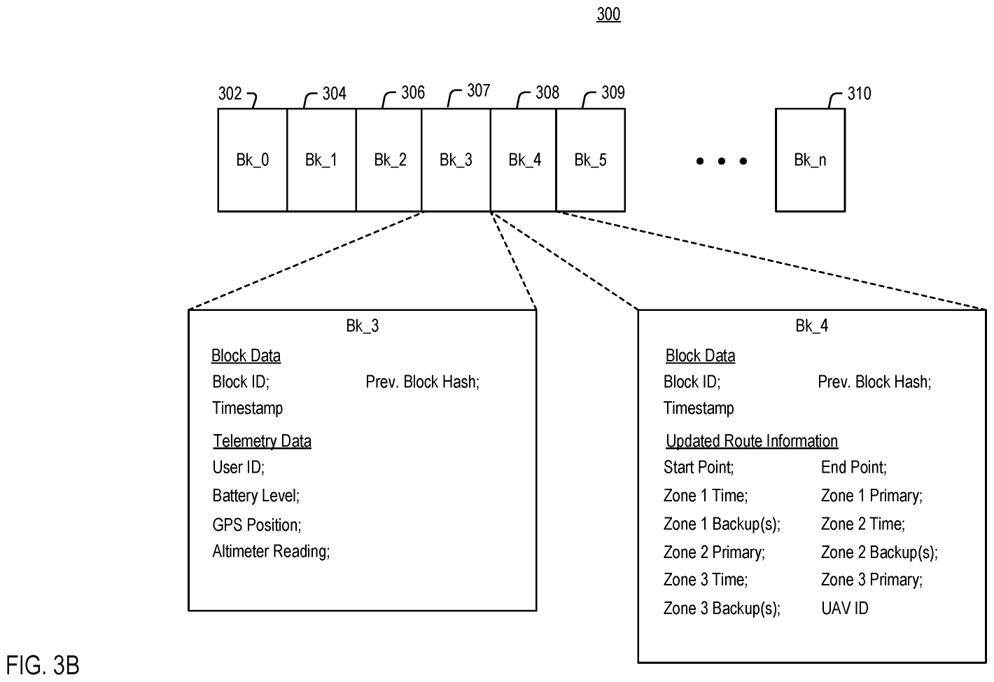

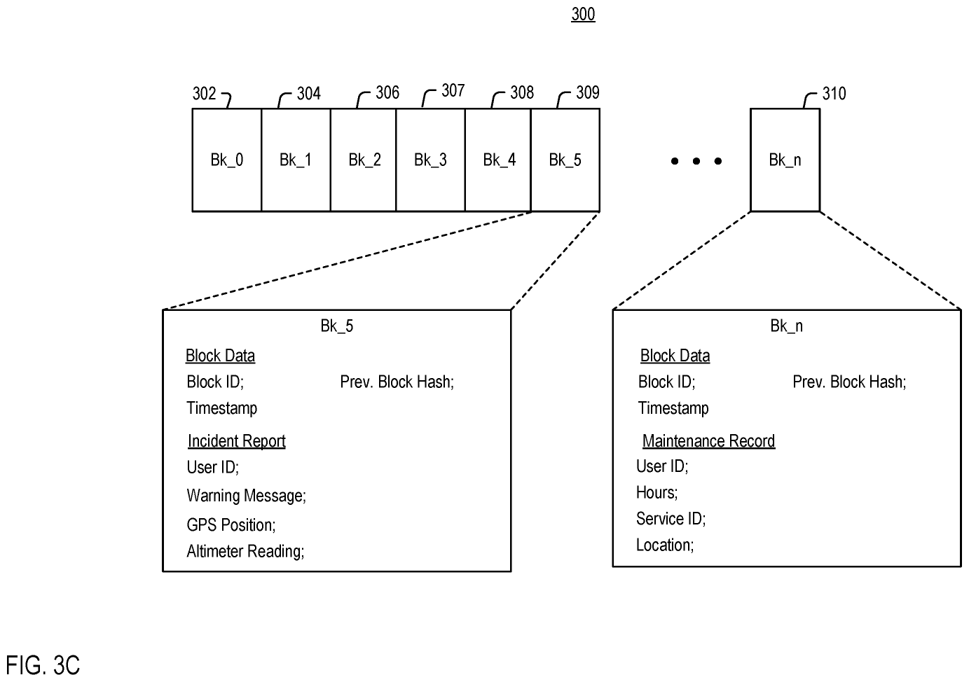

The blockchain data structure 156 may include, among other things, route information associated with the UAV 102, the telemetry data 107, the control instructions 130, and the route instructions 148. For example, the route information 110 may be used to generate blocks of the blockchain data structure 156. A sample blockchain data structure 300 is illustrated in FIGS. 3A-3C. Each block of the blockchain data structure 300 includes block data and other data, such as availability data, route data, telemetry data, service information, incident reports, etc.

The block data of each block includes information that identifies the block (e.g., a block ID) and enables the devices of the system 100 to confirm the integrity of the blockchain data structure 300. For example, the block data also includes a timestamp and a previous block hash. The timestamp indicates a time that the block was created. The block ID may include or correspond to a result of a hash function (e.g., a SHA(256) hash function, a RIPEMD hash function, etc.) based on the other information (e.g., the availability data or the route data) in the block and the previous block hash (e.g., the block ID of the previous block). For example, in FIG. 3A, the blockchain data structure 300 includes an initial block (Bk_0) 302 and several subsequent blocks, including a block Bk_1 304, a block Bk_2 306, a block BK_3 307, a block BK_4 308, a block BK_5 309, and a block Bk_n 310. The initial block Bk_0 302 includes an initial set of availability data or route data, a timestamp, and a hash value (e.g., a block ID) based on the initial set of availability data or route data. As shown in FIG. 1, the block Bk_1 304 also may include a hash value based on the other data of the block Bk_1 304 and the previous hash value from the initial block Bk_0 302. Similarly, the block Bk_2 306 other data and a hash value based on the other data of the block Bk_2 306 and the previous hash value from the block Bk_1 304. The block Bk_n 310 includes other data and a hash value based on the other data of the block Bk_n 310 and the hash value from the immediately prior block (e.g., a block Bk_n-1). This chained arrangement of hash values enables each block to be validated with respect to the entire blockchain; thus, tampering with or modifying values in any block of the blockchain is evident by calculating and verifying the hash value of the final block in the block chain. Accordingly, the blockchain acts as a tamper-evident public ledger of availability data and route data for the system 100.

In addition to the block data, each block of the blockchain data structure 300 includes some information associated with a UAV (e.g., availability data, route information, telemetry data, incident reports, updated route information, maintenance records, UAV software modules in use, etc.). For example, the block Bk_1 304 includes availability data that includes a user ID (e.g., an identifier of the mobile device, or the pilot, that generated the availability data), a zone (e.g., a zone at which the pilot will be available), and an availability time (e.g., a time period the pilot is available at the zone to pilot a UAV). As another example, the block Bk_2 306 includes route information that includes a UAV ID, a start point, an end point, waypoints, GPS coordinates, zone markings, time periods, primary pilot assignments, and backup pilot assignments for each zone associated with the route.

In the example of FIG. 3B, the block BK_3 307 includes telemetry data, such as a user ID (e.g., an identifier of the UAV that generated the telemetry data), a battery level of the UAV; a GPS position of the UAV; and an altimeter reading. As explained in FIG. 1, a UAV may include many types of information within the telemetry data that is transmitted to the blockchain managers of the computers within the distributed computing network 151. In a particular embodiment, the UAV is configured to periodically broadcast to the network 118, a transaction message that includes the UAV's current telemetry data. The blockchain managers of the distributed computing network receive the transaction message containing the telemetry data and store the telemetry data within the blockchain data structure 156.

FIG. 3B also depicts the block BK_4 308 as including updated route information having a start point, an endpoint, and a plurality of zone times and backups, along with a UAV ID. In a particular embodiment, the user device 120 or the server 140 may determine that the route of the UAV should be changed. For example, the control device or the server may detect that the route of the UAV conflicts with a route of another UAV or a developing weather pattern. As another example, the control device or the server many determine that the priority level or concerns of the user have changed and thus the route needs to be changed. In such instances, the control device or the server may transmit to the UAV, updated route information, control data, or navigation information. Transmitting the updated route information, control data, or navigation information to the UAV may include broadcasting a transaction message that includes the updated route information, control data, or navigation information to the network 118. The blockchain manager 155 in the distributed computing network 151, retrieves the transaction message from the network 118 and stores the information within the transaction message in the blockchain data structure 156.

FIG. 3C depicts the block BK_5 309 as including data describing an incident report. In the example of FIG. 3C, the incident report includes a user ID; a warning message; a GPS position; and an altimeter reading. In a particular embodiment, a UAV may transmit a transaction message that includes an incident report in response to the UAV experiencing an incident. For example, if during a flight mission, one of the UAV's propellers failed, a warning message describing the problem may be generated and transmitted as a transaction message.

FIG. 3C also depicts the block BK_n 310 that includes a maintenance record having a user ID of the service provider that serviced the UAV; flight hours that the UAV had flown when the service was performed; the service ID that indicates the type of service that was performed; and the location that the service was performed. UAV must be serviced periodically. When the UAV is serviced, the service provider may broadcast to the blockchain managers in the distributed computing network, a transaction message that includes service information, such as a maintenance record. Blockchain managers may receive the messages that include the maintenance record and store the information in the blockchain data structure. By storing the maintenance record in the blockchain data structure, a digital and immutable record or logbook of the UAV may be created. This type of record or logbook may be particularly useful to a regulatory agency and an owner/operator of the UAV.

Referring back to FIG. 1, in a particular embodiment, the server 140 may include a UAV software module that is configured to receive telemetry information from an airborne UAV and track the UAV's progress and status. The server 140 is also configured to transmit in-flight commands to the UAV 102. Operation of the user device 120 and the server 140 may be carried out by some combination of a human operator and autonomous software (e.g., artificial intelligence (AI) software that is able to perform some or all of the operational functions of a typical human operator pilot).

In a particular embodiment, the route instructions 148 cause the server 140 to plan a flight path, generate route information, dynamically reroute the flight path and update the route information based on data aggregated from a plurality of data servers. For example, the server 140 may receive air traffic data 167 over the network 119 from the air traffic data server 160, weather data 177 from the weather data server 170, regulatory data 187 from the regulatory data server 180, and topographical data 197 from the topographic data server 190. It will be recognized by those of skill in the art that other data servers useful in-flight path planning of a UAV may also provide data to the server 140 over the network 118 or through direct communication with the server 140. Additionally, communication with each data server may be enabled through the use of a UAV software module as described herein.

The air traffic data server 160 may include a processor 162, memory 164, and communication circuitry 168. The memory 164 of the air traffic data server 160 may include operating instructions 166 that when executed by the processor 162 cause the processor to provide the air traffic data 167 about the flight paths of other aircraft in a region, including those of other UAVs. The air traffic data may also include real-time radar data indicating the positions of other aircraft, including other UAVs, in the immediate vicinity or in the flight path of a particular UAV. Air traffic data servers may be, for example, radar stations, airport air traffic control systems, the FAA, UAV control systems, and so on.

The weather data server 170 may include a processor 172, memory 174, and communication circuitry 178. The memory 174 of the weather data server 170 may include operating instructions 176 that when executed by the processor 172 cause the processor to provide the weather data 177 that indicates information about atmospheric conditions along the UAV's flight path, such as temperature, wind, precipitation, lightening, humidity, atmospheric pressure, and so on. Weather data servers may be, for example, the National Weather Service (NWS), the National Oceanic and Atmospheric Administration (NOAA), local meteorologists, radar stations, other aircraft, and so on.

The regulatory data server 180 may include a processor 182, memory 184, and communication circuitry 188. The memory 184 of the weather data server 170 may include operating instructions 186 that when executed by the processor 182 cause the processor to provide the regulatory data 187 that indicates information about laws and regulations governing a particular region of airspace, such as airspace restrictions, municipal and state laws and regulations, permanent and temporary no-fly zones, and so on. Regulatory data servers may include, for example, the FAA, state and local governments, the Department of Defense, and so on.

The topographic data server 190 may include a processor 192, memory 194, and communication circuitry 198. The memory 194 of the topographic data server 190 may include operating instructions 196 that when executed by the processor 192 cause the processor to provide the topographical data that indicates information about terrain, places, structures, transportation, boundaries, hydrography, ortho-imagery, land cover, elevation, and so on. Topographic data may be embodied in, for example, digital elevation model data, digital line graphs, and digital raster graphics. Topographic data servers may include, for example, the United States Geological Survey or other geographic information systems (GISs).

In some embodiments, the server 140 may aggregate data from the data servers 160, 170, 180, 190 using application program interfaces (APIs), syndicated feeds and eXtensible Markup Language (XML), natural language processing, JavaScript Object Notation (JSON) servers, or combinations thereof. Updated data may be pushed to the server 140 or may be pulled on-demand by the server 140. Notably, the FAA may be an important data server for both airspace data concerning flight paths and congestion as well as an important data server for regulatory data such as permanent and temporary airspace restrictions. For example, the FAA provides the Aeronautical Data Delivery Service (ADDS), the Aeronautical Product Release API (APRA), System Wide Information Management (SWIM), Special Use Airspace information, and Temporary Flight Restrictions (TFR) information, among other data. The National Weather Service (NWS) API allows access to forecasts, alerts, and observations, along with other weather data. The USGS Seamless Server provides geospatial data layers regarding places, structures, transportation, boundaries, hydrography, ortho-imagery, land cover, and elevation. Readers of skill in the art will appreciate that various governmental and non-governmental entities may act as data servers and provide access to that data using APIs, JSON, XML, and other data formats.

Readers of skill in the art will realize that the server 140 can communicate with a UAV 102 using a variety of methods. For example, the UAV 102 may transmit and receive data using Cellular, 5G, Sub1 GHz, SigFox, WiFi networks, or any other communication means that would occur to one of skill in the art.

The network 119 may comprise one or more Local Area Networks (LANs), Wide Area Networks (WANs), cellular networks, satellite networks, internets, intranets, or other networks and combinations thereof. The network 119 may comprise one or more wired connections, wireless connections, or combinations thereof.

The arrangement of servers and other devices making up the exemplary system illustrated in FIG. 1 are for explanation, not for limitation. Data processing systems useful according to various embodiments of the present disclosure may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), and others as will occur to those of skill in the art. Various embodiments of the present invention may be implemented on a variety of hardware platforms in addition to those illustrated in FIG. 1.

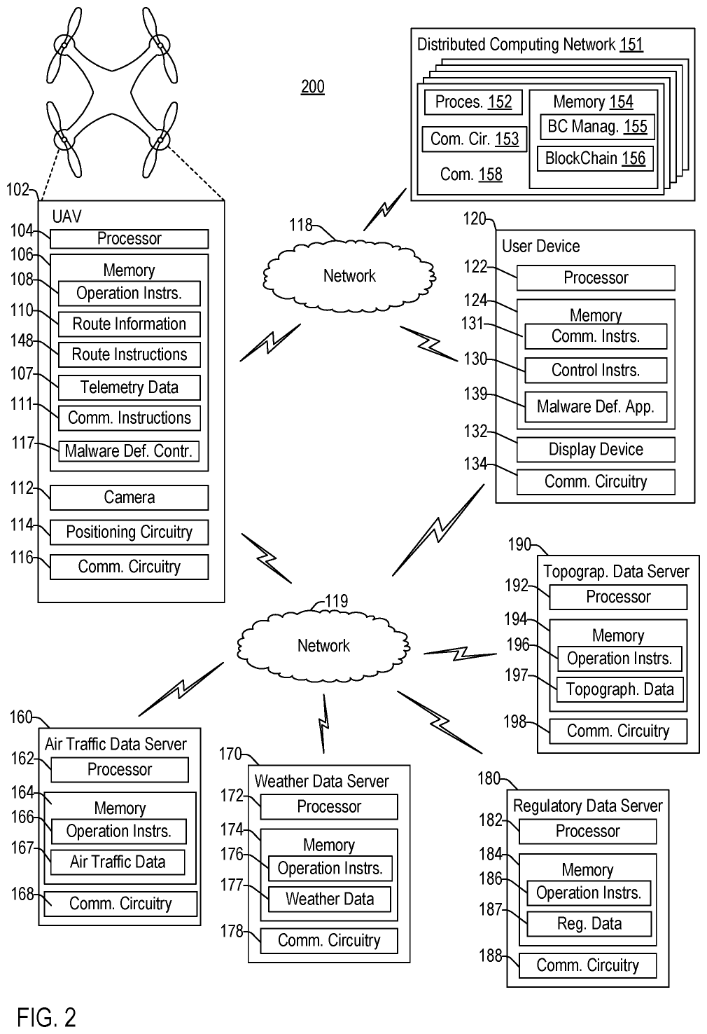

For further explanation, FIG. 2 sets forth a block diagram illustrating another implementation of a system 200 of providing malware protection on a UAV. Specifically, the system 200 of FIG. 2 shows an alternative configuration in which one or both of the UAV 102 and the server 140 may include route instructions 148 for generating route information. In this example, instead of relying on a server 140 to generate the route information, the UAV 102 and the user device 120 may retrieve and aggregate the information from the various data sources (e.g., the air traffic data server 160, the weather data server 170, the regulatory data server 180, and the topographical data server 190). As explained in FIG. 1, the route instructions may be configured to use the aggregated information from the various source to plan and select a flight path for the UAV 102.

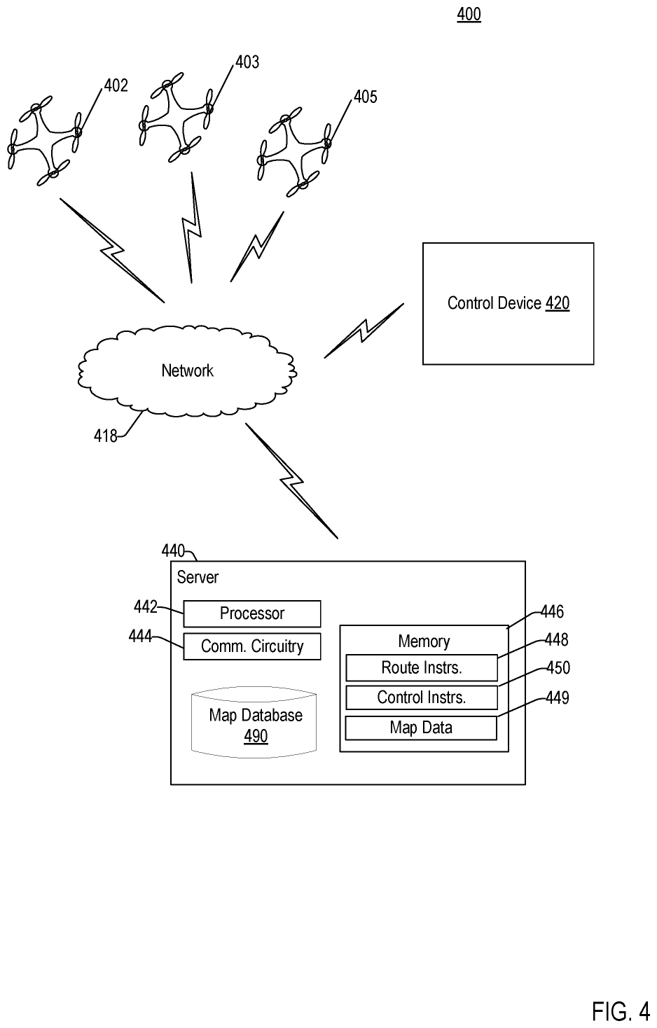

For further explanation, FIG. 4 sets forth a block diagram illustrating a particular implementation of a system 400 for updating airspace awareness for unmanned aerial vehicles according to some embodiments of the present disclosure. The system 400 includes the first UAV 402, a second UAV 403, a third UAV 405, which may be similarly configured to the UAV 102 of FIG. 1 and FIG. 2. The system 400 also includes a control device 420 may be similarly configured to the user device 120 of FIG. 1 and FIG. 2. The system 400 also includes a map server 440 that may be implemented by the server 140 of FIG. 1 or by another computing device communicating with the UAVs 402, 403, 405 and/or the control device 420. When the map server 440 is another computing device not depicted in FIG. 1 or FIG. 2, the map server may also include a processor 442 coupled to communication circuitry 444 and a memory 446. The memory 446 may include operating instructions 448 that are configured to transmit map data 449 via the communication circuitry 444 to the UAVs 402, 403, 405 and/or the control device 420. In some examples, the map data 449 includes data related to an environmental or airspace awareness map. The memory may also include control instructions 450 that include instructions or code that cause the server 440 to generate control data to transmit to one or more UAVs 402, 403, 405 to enable the server 440 to control one or more operations of the UAV during a particular time period.

The map server 440 maintains a map database 490. In some examples, the map database 490 includes indications of particular locations that should be avoided by a UAV because they are locations where UAV flight would, for example, pose a risk to the UAV. While in some examples the map database 490 identifies the location with a tag indicating the location that should be avoided in a UAV flight path, in other examples the map database 490 may also include a tag of an environmental condition at the location that is to be avoided. For example, the tag may include the type of environmental condition or other details about the environmental condition.

In some implementations, the map server 440 acts as a central repository for the map database 490 and modifications to it. In these implementations, the server 440 provides map data 449 to the UAVs 402, 403, 405 and the control device 420 for route planning, navigation, and UAV missions. Accordingly, the memory the UAVs 402, 403, 405 or the memory of the control device 420 may include a local copy of a map generated from airspace awareness map data 449. The UAVs 402, 403, 405 or the control device 420 may load map relevant to the intended flight path of the UAV from the map server 440 during prior to initiating a mission. The UAVs 402, 403, 405 or the control device 420 may also load map relevant to the current flight path of the UAV from the map server 440 on-demand while the UAV is in flight. In addition to route planning and navigation, the UAVs 402, 403, 405 and the control device 420 may load a map from the map sever 440 that includes tags and locations of environmental conditions that are relevant to the UAV's mission. The UAVs 402, 403, 405 or the control device 420 may also generate updates to the map database 490 that are provided to the map server 440 based on in-flight observations, and the server 440 may propagate updates received from one UAV to other UAVs.

In a particular embodiment, the UAVs 402, 403, 405, the map server 440, the control device 420 are coupled for communication to a network 418. The network 418 may include a cellular network, a satellite network or another type of network that enables wireless communication between the UAVs 402, 403, 405, the server 440, the control device 420. In an alternative implementation, the UAVs 402, 403, 405, the server 440, the control device 420 communicate with each other via separate networks (e.g., separate short range networks). While only one control device 420 is illustrated, it will be appreciated that each UAV 402, 403, 405 may be operated by a distinct control device or the same control device.

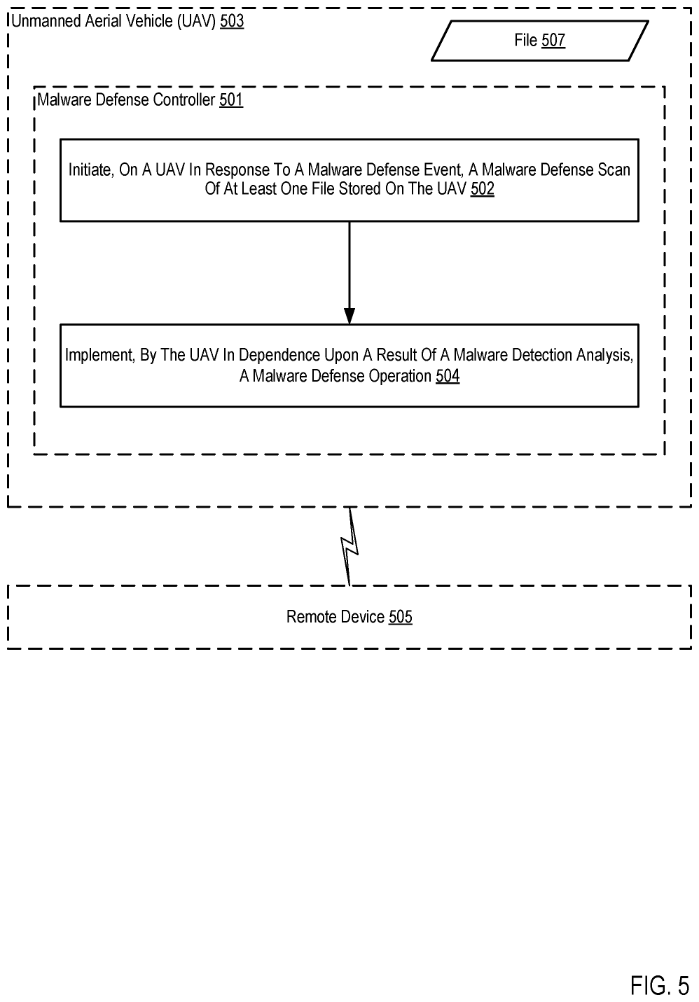

For further explanation, FIG. 5 sets forth a flow chart illustrating an exemplary method of providing malware protection on a UAV in accordance with at least one embodiment of the present disclosure. In the example of FIG. 5, a UAV 503 communicates with at least one remote device 505 associated with the UAV 503, such as a remote control device (e.g., the user device 120 of FIGS. 1 and 2 or the control device 420 of FIG. 4) or a remote server (e.g., the server 140 of FIGS. 1 and 2 or the server 440 of FIG. 4). The example method of FIG. 5 includes initiating 502, on a UAV 503 in response to a malware defense event, a malware defense scan of at least one file 507 stored on the UAV. In a particular embodiment, initiating 502, on a UAV 503 in response to a malware defense event, a malware defense scan of at least one file 507 stored on the UAV is carried out by a malware defense controller 501. The malware defense controller 501 may include a set of computer program instructions that are executed by a processor. In some embodiments, as depicted in FIG. 5, the malware defense controller 501 may be executed on the UAV 503. For example, the malware defense controller 501 of FIG. 5 may be the malware defense controller 117 of FIGS. 1 and 2. In other embodiments, some aspects of the malware defense controller 501 may be executed on the remote device 505. For example, some aspects of the malware defense controller 501 may be carried out by the malware defense application 139 of FIGS. 1 and 2 or the malware defense application 145 of FIG. 1.

In various examples, the malware defense controller 501 identifies an event that triggers the malware defense scan. In some examples, where the malware defense controller 501 executes on the UAV 503, the event can be a command received from a remote device such as a remote control device (e.g., the user device 120 of FIGS. 1 and 2 or the control device 420 of FIG. 4) or a remote server (e.g., the server 140 of FIGS. 1 and 2 or the server 440 of FIG. 4). In these examples, the malware defense controller 501 of the UAV 503 receives a message from the remote device 505 that includes an instruction to perform the malware defense scan. In other examples, where the malware defense controller 501 executes on the UAV 503, the event can be a scheduled malware defense scan. For example, the malware defense controller 501 can initiate the malware defense scan in response to identifying a scheduled event (e.g., once a day, once a week, etc.) for performing the malware defense scan.

In further examples, where the malware defense controller 501 executes on the UAV 503, the event can be the receipt of one or more files from the remote device 505, another UAV (not shown), or some other computing device. For example, the one or more files can include an executable file such as a software update to one or more applications or processes that execute on the UAV 503, or may be a new executable file. In recognition that malware can be hidden in non-executable files, the one or more files can also include non-executable files such as flight plan data (e.g., flight missions) or map data.

In still further examples, where the malware defense controller 501 executes on the UAV 503, the event can be the detection of anomalous behavior of the UAV 503 or components thereof. For example, the malware defense controller 501 may detect the receipt or transmission of an anomalous data stream, such as the receipt or transmission of data to/from a device that is not a device associated with the UAV 503. In another example, the malware defense controller 501 may detect anomalous flight behavior, such as a deviation from an existing flight path. In yet another example, the malware defense controller may detect that particular components or functions have been disabled. For example, the malware defense controller 501 may detect that the transmission of location information or other communication has been disabled. In still another example, the malware defense controller 501 may identify that a particular application or process is requesting, or has been granted, one or more permissions that is reserved for UAV system functions or that is outside of the scope of the application or process. For example, a suspicious application may request control of the propellers where such control is reserved for a flight control process, or access to the sensors where such access is beyond the needs of the suspicious application.

In additional examples, where the malware defense controller 501 executes on the remote device 505, the event can be a scheduled malware defense scan. For example, the malware defense controller 501 can initiate the malware defense scan in response to identifying a scheduled event (e.g., once a day, once a week, etc.) for performing the malware defense scan. In such an example, the malware defense controller 501 executing on the remote device 505 may send a message to the UAV 503 indicating that the malware defense scan should be performed. In further examples, where the malware defense controller 501 executes on the remote device 505, the event can be a notification from the UAV 503 indicating that a new file has been received by the UAV 503. In such examples, the malware defense controller 501 executing on the remote device 505 may send a message to the UAV 503 indicating that the malware defense scan should be performed. In still further examples, where the malware defense controller 501 executes on the remote device 505, the event can be the detection of anomalous behavior of the UAV 503 or components thereof. For example, the malware defense controller 501 on the remote device 505 may detect the receipt or transmission of an anomalous data stream by the UAV 503, such as the receipt or transmission of data to/from a device that is not a device associated with the UAV 503. In another example, the malware defense controller 501 on the remote device 505 may detect anomalous flight behavior, such as a deviation from an existing flight path or deviation from a scheduled mission. In yet another example, the malware defense controller 501 may detect that particular components or functions of the UAV 503 have been disabled. For example, the malware defense controller 501 on the remote device 505 may detect that the transmission of location information or other communication from the UAV 503 has been disabled.

In some embodiments, initiating 502, on a UAV 503 in response to a malware defense event, a malware defense scan of at least one file 507 stored on the UAV is carried out by a call from the malware defense controller to a malware detection routine that performs the malware defense analysis. The malware detection routine may include a set of computer program instructions that are executed by a processor. In some examples, as depicted in FIG. 5, the malware detection routine is a sub-process or component of the malware defense controller 501 on the UAV 503. In other examples, the malware detection routine is an independent process. In various examples, the malware detection routine can be called by the malware defense controller executing on the UAV 503, as depicted in FIG. 5, or by the malware defense controller executing on the remote device 505 associated with the UAV 503. In some examples, the malware detection routine carries out a malware defense scan on one or more identified files. For example, the one or more identified files can be files associated with the anomalous behavior of the UAV 503 (e.g., as discussed above). In another example, the one or more identified files can be files that have been recently received by the UAV 503, such as a newly received file or a previously received file that has not yet been the subject of a malware defense scan. In still further examples, the malware defense scan can be performed on all files stored on the UAV 503.

The example method of FIG. 5 also includes implementing 504, by the UAV 503 in dependence upon a result of a malware detection analysis, a malware defense operation. In some embodiments, implementing 504, by the UAV 503 in dependence upon a result of a malware detection analysis, a malware defense operation may be carried out by the malware defense controller 501. When a result of a malware detection analysis (e.g., carried out by the malware detection routine) indicates that one or more files includes or is suspected to include malware, the malware defense operation is performed to restrict or remove the malware, or mitigate the effects of the malware. As such, implementing 504 the malware defense operation can include quarantining the file. If the file that is suspected malware is associated with a currently executing process, implementing 504 the malware defense operation can include forcing a stop of the process and quarantining the associated file. If the executing process cannot be stopped, implementing 504 the malware defense operation can include limiting the executing process by suspending permissions granted to the process or restricting access to system memory or storage on the UAV 503.

In some examples, implementing 504 the malware defense operation includes placing the UAV 503 into a limited operational state or ‘safe’ mode. In some implementations, placing the UAV 503 into safe mode limits the functionality of the UAV 503. For example, network communications (e.g., cellular and satellite network communication) may be disabled while in safe mode, thus inhibiting a continued cyber attack or the spread of infected data to other UAVs or control devices. In another example, a camera feed and/or sensor data feed is disabled while in safe mode. In one example, placing the UAV 503 into safe mode spawns a secondary UAV operation process that overrides a current primary UAV operation process (i.e., embodied by the operation instructions 108) and that does not share configuration information with the primary UAV operation process. That is, the secondary UAV operation process may utilize distinct configuration information that can be isolated from the malware. Where the primary UAV operation process may have been infected with or coopted by malware, instantiation of the secondary UAV operation process can allow safe navigation of the UAV to a recovery point.

In some examples, implementing 504 the malware defense operation includes autonomously executing an emergency landing procedure. In one example, in response to a result indicating the presence of malware on the UAV 503, the UAV 503 automatically and autonomously navigates to a home coordinate and lands. For example, the home coordinate may be the coordinate where flight was initiated or a preset home coordinate. In another example, the UAV 503 automatically and autonomously identifies a nearest safe landing zone and lands. Upon completing the emergency landing procedure, the UAV 503 may disable itself and await recovery by an operator. It should be recognized that the malware defense operation may include combinations of any of the above-described malware defense operations.

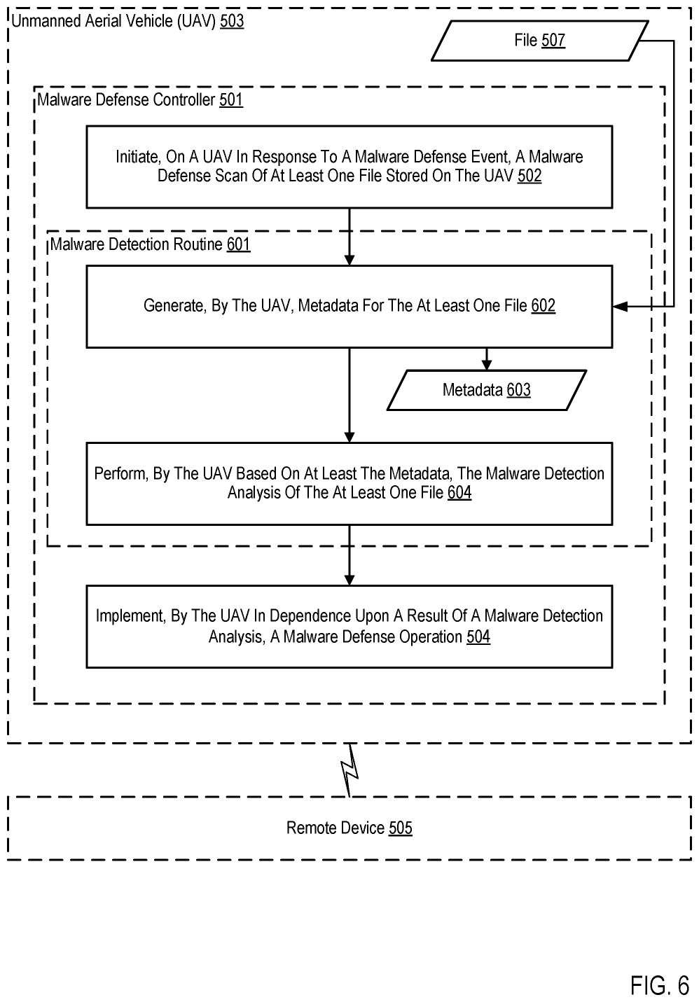

For further explanation, FIG. 6 sets forth a flow chart illustrating an exemplary method of providing malware protection on a UAV in accordance with at least one embodiment of the present disclosure. The method of FIG. 6 is similar to the method of FIG. 5 in that the method of FIG. 6 also includes initiating 502, on a UAV 503 in response to a malware defense event, a malware defense scan of at least one file 507 stored on the UAV; and implementing 504, by the UAV 503 in dependence upon a result of a malware detection analysis, a malware defense operation.

The example method of FIG. 6 also includes generating 602, by the UAV 503, metadata 603 for the at least one file 507. As described above, in some examples the malware detection controller 501 calls a malware detection routine 601 in response to an event that elicits the malware defense scan. In some examples, as depicted in FIG. 6, the malware detection routine 601 is a sub-process of the malware detection controller 501. However, in other examples the malware detection routine 601 may be a separate application or process. In a particular embodiment, the malware detection routine is embodied in a set of computer program instructions that are executed by a processor. In some examples, as a first step of the malware defense scan, the malware detection routine 601 identifies at least one file 507 that is the target of the malware defense scan and generates 602 metadata 603 for the at least one file 507.

In some implementations, generating 602, by the UAV 503, metadata 603 for the at least one file 507 includes calculating a hash of the at least one file 507. In some examples, the malware detection routine 601 applies a hash function to generate a hash value of the entire file 507 or for portions of the file 507. For example, the malware detection routine 601 may apply the secure hash algorithm 256 (SHA-256) hash function to the files 507 or portions of the file 507. The hash value(s) associated with the file 507 represent a digital signature of the file 507 that can be compared to a manifest of malware definitions. In some examples, generating 602, by the UAV 503, metadata 603 for the at least one file 507 can also include generating metadata 603 that describes attributes of the file 507, such as requested permissions, API class references, size, storage location, and so on.

In some implementations, the metadata includes pattern data that are supplied to a trained model that can identify suspected malware. In such implementations, generating 602, by the UAV 503, metadata 603 for the at least one file 507 includes generating pattern data for the file 507. In some examples, the pattern data indicates a data pattern exhibited by the file 507. For example, the pattern may be extracted from a binary representation of the file 507. In such an example, the malware defense routine can identify patterns in the ‘1’s and ‘0’s in the binary representation of the file 507. In some examples, these patterns can be compared to patterns that have been extracted from known malware files. In other examples, these patterns can be supplied to a trained classification model, as will be explained in greater detail below.

In a particular example, generating 602, by the UAV 503, metadata 603 for the at least one file 507 is carried out by generating a pattern vector for the file 507. In this example, the pattern vector represents patterns extracted from the binary representation of the file 507. First, features are extracted from the file 507. In one example, printable characters (e.g., ASCII characters) are extracted from the binary representation of the file 507. For example, the printable characters can be extracted by portioning the binary representation of the file into, for example, 8 bit strings and translating the string into a character. As one example, the binary string ‘01100001’ translates to a lower case ‘a’ in the ASCII character space. The feature extraction can be carried out on all or a subset of the binary representation of the file 507, which results in a string of extracted characters. Next, one or more pattern vectors is generated based occurrences of character n-grams of the extracted string.

In one example, an n-gram refers to sequence of n values in the extracted string, where n is a positive integer greater than or equal to two. In some implementations, as described further below, the malware detection routine 601 may generate more than one vector based on the extracted string. In some examples, the n-grams used to generate the pattern vectors may include contiguous sequences of values (i.e., zero-skip grams), discontinuous sequences of values (i.e., skip grams), or both.

As one example, a pattern vector can include values representing occurrence of n-grams (e.g., pairs when n=2, triplets when n=3, etc.) of printable characters of the extracted string. The n-grams can represent adjacent characters in the string or nonadjacent characters in the string. For example, for a bi-gram (e.g., n=2), a pair of nonadjacent characters may include characters that are separated by at least one other character (e.g., a one-skip gram), at least two other characters (e.g., a two-skip gram), and so on. In another example, a pattern vector can include n-grams of more than two characters, such as a three character n-gram (e.g., n=3).

In a particular example, a pattern vector includes values representing occurrence of n-grams (e.g., pairs of characters, groups of characters) in the extracted string. For example, a pattern vector can indicate occurrences of zero-skip bi-grams in the extracted string. In this example, the pattern vector includes one field for each possible bi-gram (based on characters that are permitted to be included in the extracted string. To illustrate, if the malware detection routine 601 includes only lowercase English letters and spaces in pattern vectors, then there are 27 distinct characters permitted in the extracted string (corresponding to a-z and a space character). Each bi-gram may include any of the 27 permitted characters as a first character and any of the 27 permitted characters as a second character. Thus, there are 27×27 (or 729) possible bi-grams based on the characters permitted in the extracted string. In this example, a pattern vector may include 729 fields, each field indicating a number of occurrences of a corresponding bi-gram. In another implementation, the pattern vector for the extracted string may be a Boolean vector, where each entry corresponding to an n-gram is ‘0’ or ‘1’ based on the occurrence of that n-gram.

Thus, in some implementations, the malware detection routine 601 generates multiple pattern vectors for a particular file 507 based on various types of n-grams for an extracted string. For example, the malware detection routing 601 can generate one pattern vector for zero-skip two-character n-grams (n=2), one pattern vector for zero-skip three-character n-grams (n=3), one pattern vector for zero-skip four-character n-grams (n=4), and so on, as well as additional pattern vectors for one-skip n-grams, two-skip n-grams, and so on. That is, each pattern vector can correspond to particular combination of the number of characters in the n-gram and the number of skips between characters.

In some implementations, a hash function may be applied to the possible character n-grams to generate a reduced character n-gram representation. The hash function may be selected to cause the reduced character n-gram representation to have a particular size. For example, multiple possible n-grams may correspond to the same n-gram after application of the hashing function, thereby reducing the total number of possible n-grams.

In some examples, the malware detection routine 601 generates pattern vectors based on patterns of entropy indicators. In one example, the malware detection routine 601 portions the binary representation of the file 507 into chunks and calculates an entropy (e.g., a Shannon entropy) for each of the chunks. For example, if a binary representation of the file 507 is divided into 10 chunks, 10 entropy values will be calculated.

In one example, the entropy values are used to generate entropy indicators. In one implementation, each of the entropy values is assigned an entropy indicator corresponding to an entropy range that includes the entropy value. For example, the possible range of entropy values can be divided into, e.g., 5 entropy indicator ranges where entropy indicator range is assigned an entropy indicator (e.g., ‘a’, ‘c’, ‘d’, e′). To illustrate, the entropy value calculated for a first chunk of the file 507 may correspond to an entropy value of 2.5. The entropy value of 2.5 is within a range of entropy values 2-3 associated with an entropy indicator ‘c’. Accordingly, an entropy indicator ‘c’ is included as the first entropy indicator in a string of entropy indicators associated with the file 507. If the file 507 is portioned into 10 chunks, 10 entropy indicators are included in the string of entropy indicators. As another example, the entropy values for the file 507 may include a second entropy value of 4.3 for a second chunk, which is represented in the string of entropy indicators by an entropy indicatory ‘e’. The length of the string of entropy indicators depends on the length of the binary representation of the file 507 (or how many chunks are generated based on the binary representation of the file 507).

In some implementations, the malware detection routine 601 generates entropy pattern vectors using n-gram combinations of the entropy indicators based on a process similar to the process described above with respect to character n-grams of character combinations extracted from the binary representation of the file 507. For example, the malware detection routine 601 can generate a pattern vector corresponding to zero-skip two entropy indicator bi-gram (n=2) that indicates occurrences of zero-skip bi-grams in the string entropy indicators. For example, if the string of entropy indicators generated from a 10-chunk file is ‘cebbadbbac’, then ‘ce’ is an entry in the vector of zero-skip bi-grams with a count of one, ‘bb’ is an entry in the vector with a count of two, and so on. In another implementation, the pattern vector for entropy indicators may be a Boolean vector, where each entry corresponding to an n-gram is ‘0’ or ‘1’ based on the occurrence of that n-gram.

In some implementations, as described above with respect to pattern vectors for an extracted string, the malware detection routine 601 generates multiple entropy indicator pattern vectors for a particular file 507 based on various types of n-grams for the string of entropy indicators. For example, the malware detection routing 601 can generate one pattern vector for zero-skip two-entropy indicator n-grams (n=2), one pattern vector for zero-skip three-entropy indicator n-grams (n=3), one pattern vector for zero-skip four-entropy indicator n-grams (n=4), and so on, as well as additional pattern vectors for one-skip n-grams, two-skip n-grams, and so on. That is, each entropy indicator pattern vector can correspond to a particular combination of the number of entropy indicators in the n-gram and the number of skips between entropy indicators.

In some embodiments, the malware detection routine 601 utilizes the collection of generated pattern vectors for the file 507 as inputs to a pattern recognition model that identifies the presence of malware in the file 507 based on the pattern vectors, as will be described in a greater detail below.

The method of FIG. 6 also includes performing 604, by the UAV 503 based on at least the metadata 603, the malware detection analysis of the at least one file 507. In some embodiments, performing 604, by the UAV 503 based on at least the metadata 603, the malware detection analysis of the at least one file 507 may be carried out by the malware detection routine 601, executing on the UAV 503, using the generated metadata 603 to determine whether the file 507 includes malware. Here, the malware detection analysis is performed on the UAV 503 in contrast to transmitting the metadata 603 to another device that performs the malware detection analysis. In one example implementation, the malware detection routine 601 compares a digital signature (e.g., a hash value) of the file 507 to a manifest of digital signatures of known malware. For example, the manifest of digital signatures may be stored in memory on the UAV 503. In one example, updates to the manifest are received from the remote device 505 as new malware is identified. When the digital signature of the file 507 matches the digital signature of known malware, the malware detection routine 601 determines that the file 507 includes malware. In another example implementation, the malware detection routine 601 utilizes one or more pattern vectors as input to a pattern recognition model. As discussed above, the pattern vectors include pattern data extracted from the file 507. In some examples, the pattern recognition model utilizes artificial intelligence to identify malware based on the pattern data in the pattern vectors. As will be discussed in greater detail below, the pattern recognition model may be a machine learning model that has been trained on vectors of pattern data that have been extracted from known malware files.

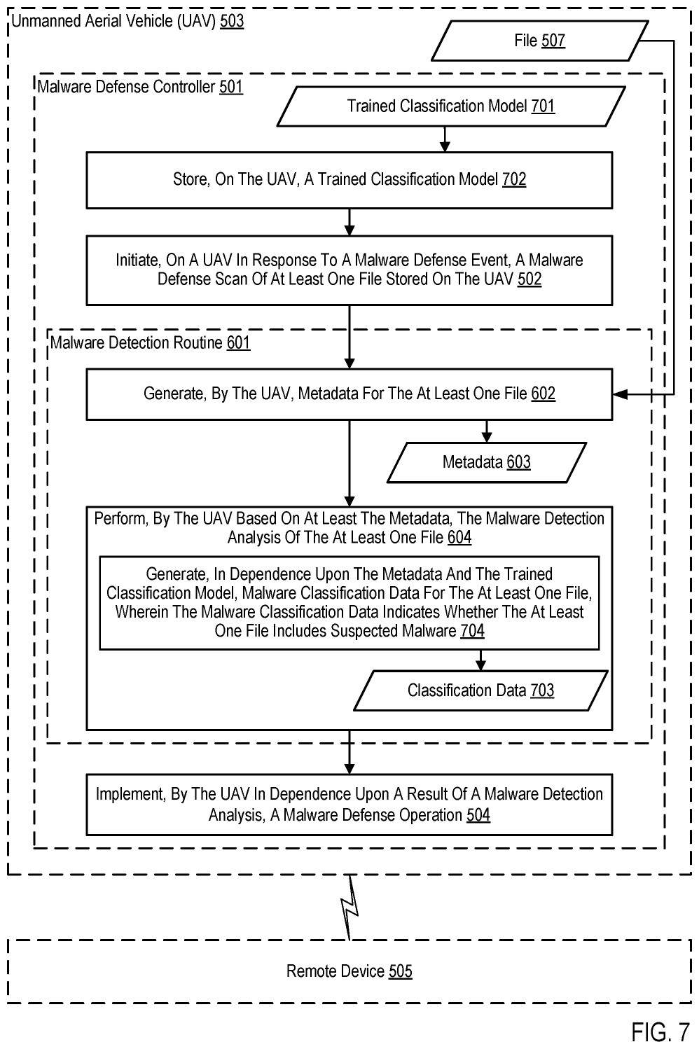

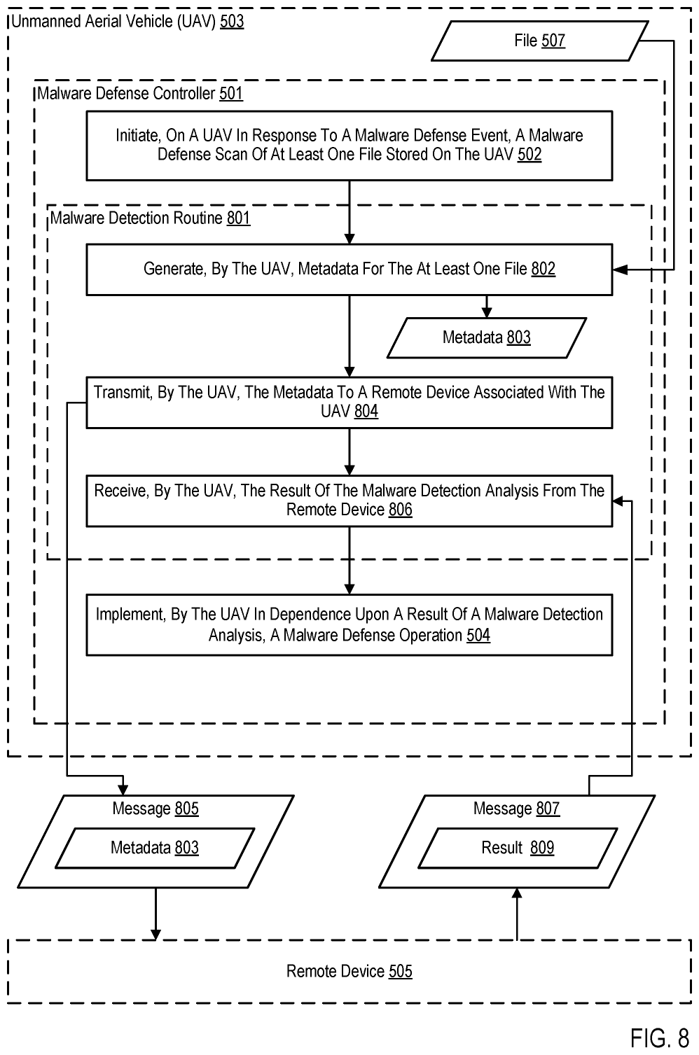

For further explanation, FIG. 7 sets forth a flow chart illustrating an exemplary method of providing malware protection on a UAV in accordance with at least one embodiment of the present disclosure. The method of FIG. 7 is similar to the method of FIG. 6 in that the method of FIG. 8 also includes initiating 502, on a UAV 503 in response to a malware defense event, a malware defense scan of at least one file 507 stored on the UAV; generating 602, by the UAV 503, metadata 603 for the at least one file 507; performing 604, by the UAV 503 based on at least the metadata 603, the malware detection analysis of the at least one file 507; and implementing 504, by the UAV 503 in dependence upon a result of a malware detection analysis, a malware defense operation.

The method of FIG. 7 also includes storing 702, on the UAV 503, a trained classification model 701. In some examples, storing 702, on the UAV 503, a trained classification model 701 may be carried out by receiving the trained classification model 701 from the remote device 505 and storing the trained classification model 701 in memory. In other examples, storing 702, on the UAV 503, a trained classification model 701 may be carried out by installing a trained classification model module on the UAV 503, where the trained classification model module includes the trained classification model 701. In these examples, the trained classification model module may include stored computer-executable instructions that implements the trained classification model 701. In other examples, the trained classification model module may include specialized hardware to accelerate software that implements the trained classification model 701. In other examples, the trained classification model module implements the trained classification model 701 using specialized hardware.

In some implementations, the trained classification model 701 is a machine learning model that has been trained on pattern vectors generated from files that contain known malware and from files that are known to be free of malware. The set of training data (i.e., pattern vectors) may be created as discussed above with respect to generating pattern vectors based on character representations of the file 507 and entropy indicators for the file 507. In various implementations, the trained classification model 701 may include a decision tree, a support vector machine, a neural network, or another type of trained data model (or application that executes based on a data model) to detect malware. For example, the trained classification model 701 may include a data structure that describes a neural network data model, where the neural network data model includes one or more input nodes, interior nodes, and output nodes. In a particular implementation, the trained classification model 701 includes a feed-forward neural network that is trained using back propagation. The feed-forward neural network may include a deep neural network (DNN) that includes at least one hidden layer. In another particular implementation, the trained classification model 701 may include a convolutional neural network (e.g., a neural network that performs one or more convolution operations), a shift invariant neural network, or a space invariant artificial neural network (SIANN). The convolutional neural network may be configured to exploit locality (e.g., spatial relationships) of patterns extracted from files.

In some examples, the trained classification model 701 is generated by a computing device having computing resources beyond those available on the UAV 503. Rather, the UAV 503 is configured with the trained classification model 701 subsequent to training the classification model 701. In some examples, the UAV 503 is configured with updates to the trained classification model 701 based the trained classification model 701 receiving additional training on additional pattern data.

In the method of FIG. 7, performing 604, by the UAV 503 based on at least the metadata 603, the malware detection analysis of the at least one file 507 also includes generating 704, in dependence upon the metadata 603 and the trained classification model 701, malware classification data 703 for the at least one file 507, wherein the malware classification data 703 indicates whether the at least one file 507 includes suspected malware. In some embodiments, generating 704, in dependence upon the metadata 603 and the trained classification model 701, malware classification data 703 for the at least one file 507, wherein the malware classification data 703 indicates whether the at least one file 507 includes suspected malware, is carried out by the malware detection routine 601 utilizing one or more pattern vectors as inputs to the trained classification model. For example, the malware detection routine 601 may feed one or more pattern vectors that include pattern data for a character string extracted from the file 507 and/or one or more pattern vectors that include pattern data for entropy indicators extracted from the file 507. In some implementations, trained classification model 701 may generate classification data that indicates that the file 507 includes malware. In these implementations, the trained classification model may also generate classification data that indicates that the file 507 does not include malware. In some implementations, the trained classification model may also generate classification data that indicates the type of malware detected, such as a virus, worm, trojan, and so on. The malware detection routine 601 identifies a result of the malware detection analysis based on the classification data generated by the trained classification model 701.

In this way, the UAV 503 can protect itself from malware attacks even when communication with the remote device 505 has been disabled. Further, the UAV 503 can respond to zero-day attacks using the trained classification model 701, which does not rely on a list of malware definitions of known malware.

For further explanation, FIG. 8 sets forth a flow chart illustrating an exemplary method of providing malware protection on a UAV in accordance with at least one embodiment of the present disclosure. The method of FIG. 8 is similar to the method of FIG. 5 in that the method of FIG. 8 also includes initiating 502, on a UAV 503 in response to a malware defense event, a malware defense scan of at least one file 507 stored on the UAV; and implementing 504, by the UAV 503 in dependence upon a result of a malware detection analysis, a malware defense operation.

The method of FIG. 8 also includes generating 802, by the UAV 503, metadata 803 for the at least one file 507. In some examples the malware detection controller 501 calls a malware detection routine 801 in response to an event that elicits the malware defense scan. In some examples, as depicted in FIG. 8, the malware detection routine 801 is a sub-process of the malware detection controller 501. However, in other examples the malware detection routine 801 may be a separate application or process. In a particular embodiment, the malware detection routine 801 is embodied in a set of computer program instructions that are executed by a processor. In some examples, as a first step of the malware defense scan, the malware detection routine 801 identifies at least one file 507 that is the target of the malware defense scan and generates 802 metadata 803 for the at least one file 507.

In some examples, the malware detection routine 801 generates 802 metadata 803 for the at least one file 507 in a manner similar to the malware detection routine 601 generating 602 metadata 603 for the at least one file. That is, in one example the malware detection routine generates metadata 803 that includes a digital signature for the file 507, as described above. In another example, the malware detection routine generates 802 metadata 803 that includes one or more pattern vectors for the file 507, as also described above.

The method of FIG. 8 also includes transmitting 804, by the UAV 503, the metadata 803 to a remote device 505 associated with the UAV 503. In one example, the remote device 505 is a remote control device or a remote server that includes a malware defense application that performs the malware detection analysis. In another example, the remote device 505 is configured to communicate with a computing device that includes a malware defense application that performs the malware detection analysis, and provides the metadata 803 to that computing device.

In some embodiments, transmitting 804, by the UAV 503, the metadata 803 to a remote device 505 associated with the UAV 503 may be carried out by the malware detection routine 801 transmitting a message 805 that includes metadata 803, which includes a digital signature (e.g., a hash value) of the file 507. For example, the message 805 can be a transaction message. In these embodiments, the message is received by the remote device 505. In one example, the malware defense application compares the digital signature of the file 507 to a manifest of digital signatures of known malware. If the malware defense application identifies a digital signature in the manifest that matches the digital signature of the file 507, the malware defense application generates a result that indicates the file 507 includes malware. If the malware defense application does not identify a digital signature in the manifest that matches the digital signature of the file 507, the malware defense application generates a result that indicates the file 507 does not include malware. In some implementations, the remote device 505 transmits a message to the UAV 503 including the result of the malware detection analysis.

In some embodiments, transmitting 804, by the UAV 503, the metadata 803 to a remote device 505 associated with the UAV 503 may be carried out by the malware detection routine 801 transmitting a message 805 that includes metadata 803, which includes one or more pattern vectors for the file 507. For example, the message 805 can be a transaction message. In these embodiments, the metadata 803 including the one or more pattern vectors is received by the remote device 505. In some implementations, the malware detection application associated with the remote device 505 includes a trained classification model, such as the trained classification model 701 described above. In some examples, the malware detection application generates classification data for the file 507 using the one or more pattern vectors as inputs to the trained classification model. In these examples, the classification data indicates whether the file 507 includes malware. In some implementations, the classification data indicates the type of malware included in the file 507, as discussed above.

The method of FIG. 8 also includes receiving 806, by the UAV 503, the result 809 of the malware detection analysis from the remote device 505. In some embodiments, receiving 806, by the UAV 503, the result 809 of the malware detection analysis from the remote device 505 is carried out by the malware detection routine 801 of the UAV 503 receiving a message 807 generated by the remote device 505 that includes a result 809 of the malware detection analysis. For example, the result 809 may indicate whether the file 507 includes malware. In some examples, the result 809 indicates the type of malware detected.

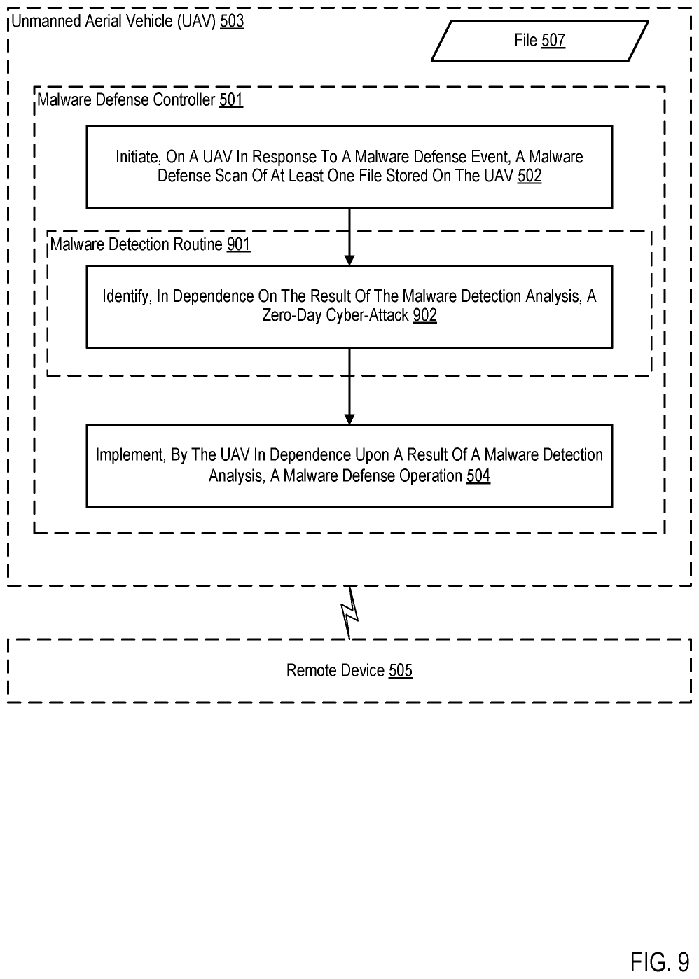

For further explanation, FIG. 9 sets forth a flow chart illustrating an exemplary method of providing malware protection on a UAV in accordance with at least one embodiment of the present disclosure. The method of FIG. 9 is similar to the method of FIG. 5 in that the method of FIG. 9 also includes initiating 502, on a UAV 503 in response to a malware defense event, a malware defense scan of at least one file 507 stored on the UAV; and implementing 504, by the UAV 503 in dependence upon a result of a malware detection analysis, a malware defense operation.

The method of FIG. 9 also includes identifying 902, in dependence on the result of the malware detection analysis, a zero-day cyber-attack. In some embodiments, identifying 902, in dependence on the result of the malware detection analysis, a zero-day cyber-attack is carried out by a malware detection routine 901 detecting malware that is not detectable based on a digital signature of the file 507. In some examples, the malware detection routine compares a digital signature of the file 507 to a manifest of digital signatures of known malware, as discussed above. In these examples, where the malware detection routine 901 does not identify a digital signature in the manifest that matches the digital signature of the file 507, the malware detection routine 901 generates one or more pattern vectors for the file, as discussed above. In some examples the one or more pattern vectors are utilized as inputs to a trained classification model. In these examples, the trained classification model generates classification data, as discussed above, that indicates whether the file 507 includes malware. Where the classification data indicates that the file 507 includes malware that was not detectable using the digital signature of the file 507, the malware detection routine has detected a zero-day cyber-attack.

Exemplary embodiments of the present invention are described largely in the context of a fully functional computer system for managing UAV software modules. Readers of skill in the art will recognize, however, that the present invention also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the invention as embodied in a computer program product. Persons skilled in the art will recognize also that, although some of the exemplary embodiments described in this specification are oriented to software installed and executing on computer hardware, nevertheless, alternative embodiments implemented as firmware or as hardware are well within the scope of the present invention.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Hardware logic, including programmable logic for use with a programmable logic device (PLD) implementing all or part of the functionality previously described herein, may be designed using traditional manual methods or may be designed, captured, simulated, or documented electronically using various tools, such as Computer Aided Design (CAD) programs, a hardware description language (e.g., VHDL or Verilog), or a PLD programming language. Hardware logic may also be generated by a non-transitory computer readable medium storing instructions that, when executed by a processor, manage parameters of a semiconductor component, a cell, a library of components, or a library of cells in electronic design automation (EDA) software to generate a manufacturable design for an integrated circuit. In implementation, the various components described herein might be implemented as discrete components or the functions and features described can be shared in part or in total among one or more components. Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of providing malware protection on an unmanned aerial vehicle (UAV), the method comprising:
initiating, on the UAV in response to a malware defense event, a malware defense scan of at least one file stored on the UAV; and
implementing, by the UAV in dependence upon a result of a malware detection analysis, a malware defense operation.

2. The method of claim 1, wherein the malware defense event is identified by the UAV.

3. The method of claim 1, wherein the malware defense event is identified by a remote device associated with the UAV.

4. The method of claim 1, wherein the malware defense operation includes a landing operation.

5. The method of claim 1 further comprising:
generating, by the UAV, metadata for the at least one file; and
performing, by the UAV based on at least the metadata, the malware detection analysis of the at least one file.

6. The method of claim 5 further comprising:
storing, on the UAV, a trained classification model;
wherein performing, by the UAV based on at least the metadata, the malware detection analysis of the at least one file includes:
generating, in dependence upon the metadata and the trained classification model, malware classification data for the at least one file, wherein the malware classification data indicates whether the at least one file includes suspected malware.

7. The method of claim 6, wherein the metadata includes one or more pattern vectors.

8. The method of claim 6, wherein the trained classification model utilizes an artificial neural network.

9. The method of claim 1 further comprising:
generating, by the UAV, metadata for the at least one file;
transmitting, by the UAV, the metadata to a remote device associated with the UAV; and
receiving, by the UAV, the result of the malware detection analysis from the remote device.

10. The method of claim 1 further comprising:
identifying, in dependence on the result of the malware detection analysis, a zero-day cyber-attack.

11. An apparatus for providing malware protection on an unmanned aerial vehicle (UAV), the apparatus comprising:
a processor; and
a non-transitory computer readable medium storing instructions that when executed by the processor, cause the apparatus to carry out operations including:
initiating, on the UAV in response to a malware defense event, a malware defense scan of at least one file stored on the UAV; and
implementing, by the UAV in dependence upon a result of a malware detection analysis, a malware defense operation.

12. The apparatus of claim 11, the operations further comprising:
generating, by the UAV, metadata for the at least one file; and
performing, by the UAV based on at least the metadata, the malware detection analysis of the at least one file.

13. The apparatus of claim 12 further comprising:
storing, on the UAV, a trained classification model;
wherein performing, by the UAV based on at least the metadata, the malware detection analysis of the at least one file includes:
generating, in dependence upon the metadata and the trained classification model, malware classification data for the at least one file, wherein the malware classification data indicates whether the at least one file includes suspected malware.

14. The apparatus of claim 13, wherein the metadata includes one or more pattern vectors.

15. The apparatus of claim 12 further comprising:
generating, by the UAV, metadata for the at least one file;
transmitting, by the UAV, the metadata to a remote device associated with the UAV; and
receiving, by the UAV, the result of the malware detection analysis from the remote device.

16. A computer program product of providing malware protection on an unmanned aerial vehicle (UAV), the computer program product disposed upon a non-transitory computer readable medium, the computer program product comprising computer program instructions that, when executed, cause a computer to carry out the operations of:
initiating, on the UAV in response to a malware defense event, a malware defense scan of at least one file stored on the UAV; and
implementing, by the UAV in dependence upon a result of a malware detection analysis, a malware defense operation.

17. The computer program product of claim 16, the operations further comprising:
generating, by the UAV, metadata for the at least one file; and
performing, by the UAV based on at least the metadata, the malware detection analysis of the at least one file.

18. The computer program product of claim 17 further comprising:
storing, on the UAV, a trained classification model;
wherein performing, by the UAV based on at least the metadata, the malware detection analysis of the at least one file includes:
generating, in dependence upon the metadata and the trained classification model, malware classification data for the at least one file, wherein the malware classification data indicates whether the at least one file includes suspected malware.

19. The computer program product of claim 18, wherein the metadata includes one or more pattern vectors.

20. The computer program product of claim 17 further comprising:
generating, by the UAV, metadata for the at least one file;
transmitting, by the UAV, the metadata to a remote device associated with the UAV; and
receiving, by the UAV, the result of the malware detection analysis from the remote device.
